(19) United States
(12) Patent Application Publication
(10) Pub. No.: US 2019/0062480 A1
(43) Pub. Date: Feb. 28, 2019

(54) CURABLE-RESIN COMPOSITION AND CURED OBJECT THEREOF

(71) Applicant: HITACHI CHEMICAL COMPANY, LTD., Chiyoda-ku, Tokyo (JP)

(72) Inventors: Kosuke YOKOYAMA, Chiyoda-ku, Tokyo (JP); Kazumasa TAKEUCHI, Chiyoda-ku, Tokyo (JP); Toshiaki SHIRASAKA, Chiyoda-ku, Tokyo (JP); Bungo OCHIAI, Yonezawa-shi, Yamagata (JP); Kazuki CHIBA, Yonezawa-shi, Yamagata (JP); Tomonari KIRYU, Yonezawa-shi, Yamagata (JP)

(21) Appl. No.: 15/753,041

(22) PCT Filed: Aug. 12, 2016
(86) PCT No.: PCT/JP2016/073789

§ 371 Date: Feb. 15, 2018

(30) Foreign Application Priority Data
Aug. 17, 2015 (JP) 2015-160619
Dec. 10, 2015 (JP) 2015-241233
Apr. 20, 2016 (JP) 2016-084665

(51) Int. Cl. C08F 220/46; C08F 220/18; C08F 220/14

(52) U.S. Cl. CPC C08F 220/46; C08F 220/18; C08F 2800/20; C08F 2220/1841; C08F 220/14

(57) ABSTRACT

Disclosed is a curable resin composition that includes radical polymerizable monomers including a first monofunctional radical polymerizable monomer and a second monofunctional radical polymerizable monomer. The first monofunctional radical polymerizable monomer is a monomer that forms, when polymerized alone, a homopolymer having a glass transition temperature of 20° C. or lower. The second monofunctional radical polymerizable monomer is a monomer that forms, when polymerized alone, a homopolymer having a glass transition temperature of 50° C. or higher.

### TECHNICAL FIELD

The present invention relates to a curable resin composition and a cured product thereof.

### BACKGROUND ART

In order to obtain a material capable of achieving a balance between elongation and resistance to folding with characteristics that are in a trade-off relationship, such as strength and elastic modulus, various investigations have been hitherto conducted. For example, Patent Literature 1 discloses a cured article having a tensile modulus of 1 to 100 MPa and a tensile elongation at break of 200% or higher. Furthermore, Patent Literature 2 discloses a material that exhibits a high elastic modulus.

Meanwhile, regarding shape memory materials, metals, resins, ceramics, and the like are known. In general, shape memory properties are manifested based on the phase transformation caused by a change in the crystal structure or a change in the form of molecular motion. Many shape memory materials have characteristics such as excellent vibration-proofing characteristics, in addition to shape restoring characteristics. Heretofore, investigations have been mainly conducted on metals and resins as the shape memory materials.

A shape memory resin is a resin that, even if the resin is deformed due to a force exerted thereto after molding processing, restores the original shape when heated to or above a certain temperature. Compared to a shape memory alloy, a shape memory resin is generally excellent from the viewpoint of being inexpensive, having a high shape change ratio, and being lightweight, easily processable, and colorable.

Shape memory resins are soft at high temperature and are easily deformed like rubber. Meanwhile, shape memory resins are hard at low temperature and are not easily deformed, as in the case of glass. Shape memory resins can be stretched by a small force at high temperature to a length that is several times the original length and can retain the deformed shape by being cooled. When the material is heated in this state under non-loaded conditions, the material restores the original shape. At a high temperature, the material restores its original shape only by eliminating the force. Therefore, the characteristics of absorption and storage of energy at high temperature can be utilized.

Principal shape memory resins include polynorbonene, trans-isoprene, styrene-butadiene copolymers, and polyurethane. For example, shape memory resins are described in relation to a norbornene-based resin in Patent Literature 3, a trans-isoprene-based resin in Patent Literature 4, a polyurethane-based resin in Patent Literature 5, and an acrylic resin in Patent Literature 6.

### CITATION LIST

### Patent Literature

Patent Literature 1: Japanese Unexamined Patent Publication No. 2008-088354

Patent Literature 2: Japanese Unexamined Patent Publication No. 2012-102193

Patent Literature 3: Japanese Examined Patent Publication H5-72405

Patent Literature 4: Japanese Unexamined Patent Publication No. 2004-250182

Patent Literature 5: Japanese Unexamined Patent Publication No. 2004-300368

Patent Literature 6: Japanese Unexamined Patent Publication No. H7-292040

### SUMMARY OF INVENTION

### Technical Problem

An object of the present invention is to provide a curable resin composition capable of forming a cured product that has high elongation at break and excellent shape restorability after being deformed under stress.

Another object of the present invention is to provide a resin molded article having shape memory properties, which exhibits excellent heating-induced shape restorability.

### Solution to Problem

An aspect of the present invention relates to a curable resin composition comprising radical polymerizable monomers that include a first monofunctional radical polymerizable monomer and a second monofunctional radical polymerizable monomer. The first monofunctional radical polymerizable monomer is a monomer that forms, when polymerized alone, a homopolymer having a glass transition temperature of 20° C. or lower. The second monofunctional radical polymerizable monomer is a monomer that forms, when polymerized alone, a homopolymer having a glass transition temperature of 50° C. or higher. The total content of the first monofunctional radical polymerizable monomer and the second monofunctional radical polymerizable monomer may be 60% by mass or more based on the total amount of the radical polymerizable monomers.

This curable resin composition can form a cured product that has high elongation at break and excellent shape restorability after being deformed under stress.

Another aspect of the present invention relates to a cured product of a curable resin composition. The curable resin composition comprises radical polymerizable monomers including a first monofunctional radical polymerizable monomer and a second monofunctional radical polymerizable monomer. The first monofunctional radical polymerizable monomer is a monomer that forms, when polymerized alone, a homopolymer having a glass transition temperature of 20° C. or lower. The second monofunctional radical polymerizable monomer is a monomer that forms, when polymerized alone, a homopolymer having a glass transition temperature of 50° C. or higher. The total content of the first monofunctional radical polymerizable monomer and the second monofunctional radical polymerizable monomer may be 60% by mass or more based on the total amount of the radical polymerizable monomers.

This cured product can have high elongation at break as well as excellent shape restorability after being deformed under stress.

Another aspect of the present invention relates to a resin molded article comprising a first polymer containing a radical polymerizable compound represented by Formula (I):

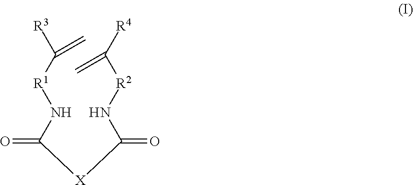

in which X, R¹, and R² each independently represent a divalent organic group; and R³ and R⁴ each represent a hydrogen atom or a methyl group, and a monofunctional radical polymerizable monomer, as monomer units; and a linear or branched second polymer.

This resin molded article may have a storage modulus of 0.5 MPa or higher at 25° C. Alternatively, the resin molded article may have shape memory properties. A relevant resin molded article has excellent heating-induced shape restorability.

Another aspect of the present invention relates to a composition for molding comprising radical polymerizable monomers (reactive monomers) including a radical polymerizable compound of Formula (I) and a monofunctional radical polymerizable monomer; and a second polymer. This composition for molding can form a resin molded article having a storage modulus of 0.5 MPa or higher at 25° C. when the radical polymerizable monomers are polymerized in the presence of the second polymer. Alternatively, this composition for molding can form a resin molded article having shape memory properties when the radical polymerizable monomers are polymerized in the presence of a second polymerizable monomer.

Another aspect of the present invention relates to a method for producing a resin molded article containing a first polymer and a second polymer. This method includes a step of producing a first polymer in a composition for molding that includes radical polymerizable monomers including a radical polymerizable compound of Formula (I) and a monofunctional radical polymerizable monomer; and a second polymer, the first polymer being produced by polymerization of the radical polymerizable monomers.

### Advantageous Effects of Invention

According to an aspect of the present invention, there is provided a curable resin composition capable of forming a resin molded article having high elongation at break as well as excellent shape restorability after being deformed under stress. According to a curable resin composition related to several embodiments, it is possible to achieve a balance between high elastic modulus and folding resistance at a high level. Here, when it is said that a cured product has excellent shape restorability after being deformed under stress, it implies that the cured product can easily restore the shape before being subject to stress, only by being relieved from stress, and this does not necessarily mean that the cured product has shape memory properties of restoring the shape as a result of heating.

According to another aspect of the present invention, a resin molded article having shape memory properties, the resin molded article having excellent heating-induced shape restorability. The rate of shape restoration when heated can be easily increased by controlling the elastic modulus of the resin molded article of the present invention. A resin molded article according to several embodiments is also excellent in view of various characteristics such as transparency, flexibility, stress relaxation characteristics, and water resistance.

### BRIEF DESCRIPTION OF DRAWINGS

FIG. 1 is a perspective view illustrating an embodiment of a resin molded article (cured product).

### DESCRIPTION OF EMBODIMENTS

Hereinafter, some embodiments of the present invention will be described in detail. However, the present invention is not intended to be limited to the following embodiments.

Curable Resin Composition

A curable resin composition according to an embodiment comprises radical polymerizable monomers that include a first monofunctional radical polymerizable monomer and a second monofunctional radical polymerizable monomer. The first monofunctional radical polymerizable monomer and the second monofunctional radical polymerizable monomer respectively have one radical polymerizable group.

The first monofunctional radical polymerizable monomer is a monomer that forms, when polymerized alone, a homopolymer having a glass transition temperature of 20° C. or lower. The second monofunctional radical polymerizable monomer is a monomer that forms, when polymerized alone, a homopolymer having a glass transition temperature of 50° C. or higher. Due to a combination of these first monofunctional polymerizable monomer and second monofunctional radical polymerizable monomer, the cured product may have high elongation at break as well as excellent shape restorability after being deformed under stress. Furthermore, there is a tendency that a cured product having high strength at break is obtained. From a similar point of view, the first radical polymerizable monomer may be a monomer that forms, when polymerized alone, a homopolymer of 10° C. or lower, or 0° C. or lower, and the second radical polymerizable monomer may be a monomer that forms, when polymerized alone, a homopolymer having a glass transition temperature of 60° C. or higher, or 70° C. or higher. The glass transition temperature of the homopolymer formed by the first monofunctional radical polymerizable monomer may also be −70° C. or higher. The glass transition temperature of the homopolymer formed by the second monofunctional radical polymerizable monomer may also be 150° C. or lower.

According to the present specification, the glass transition temperature of the homopolymer formed by each radical polymerizable monomer means a temperature determined by differential scanning calorimetry. Any person having ordinary skill in the art may know the glass transition temperatures of homopolymers of general radical polymerizable monomers from literature values.

The content of the first monofunctional radical polymerizable monomer may be 5% by mass or more, 10% by mass or more, or 15% by mass or more, and may be 90% by mass or less, 85% by mass or less, or 80% by mass or less, based on the total amount of the radical polymerizable monomers. When the content of the first radical polymerizable monomer is within these ranges, a more remarkable effect is obtained from the viewpoint that the cured product can achieve a balance between high elongation at break and high elastic modulus.

The first monofunctional radical polymerizable monomer may be an alkyl (meth)acrylate that may have a substituent. The alkyl (meth)acrylate that may have a substituent, which is used as the first monofunctional radical polymerizable monomer, may be at least one selected from the group consisting of, for example, ethyl acrylate, ethyl methacrylate, n-butyl acrylate, n-butyl methacrylate, isobutyl acrylate, isobutyl methacrylate, hexyl acrylate, hexyl methacrylate, 2-ethylhexyl acrylate, 2-ethylhexyl methacrylate, 2-hydroxyethyl methacrylate, 2-hydroxypropyl methacrylate, 2-hydroxy-1-methylethyl methacrylate, 2-methoxyethyl acrylate, and glycidyl methacrylate.

The first monofunctional radical polymerizable monomer may be 2-ethylhexyl acrylate. When 2-ethylhexyl acrylate is used, a more advantageous effect is obtained from the viewpoint that toughness and elongation at break of the cured product are increased, and control of the elastic modulus becomes easier.

The content of the second monofunctional radical polymerizable monomer may be 10% by mass or more, 15% by mass or more, or 20% by mass or more, or may be 95% by mass or less, 90% by mass or less, or 85% by mass or less, based on the total amount of the radical polymerizable monomers. When the content of the second monofunctional radical polymerizable monomers is within these ranges, a more remarkable effect is obtained from the viewpoint that the cured product can achieve a balance between high elongation at break and high elastic modulus.

The second monofunctional radical polymerizable monomer may be an alkyl (meth)acrylate that may have a substituent. The alkyl (meth)acrylate that may have a substituent, which is used as the second monofunctional radical polymerizable monomer, may be at least one selected from the group consisting of, for example, adamantly acrylate, adamanyl methacrylate, 2-cyanomethyl acrylate, 2-cyanobutyl acrylate, acrylamide, acrylic acid, methacrylic acid, acrylonitrile, dicyclopentanyl acrylate, and methyl methacrylate.

The second monofunctional radical polymerizable monomer may also be at least one selected from the group consisting of acrylonitrile, dicyclopentanyl acrylate, and methyl methacrylate. When these monomers are used, a more advantageous effect is obtained from the viewpoint that the strength at break and the elastic elongation percentage of the cured product are increased, and control of the elastic modulus becomes easier.

The ratio of the first monofunctional radical polymerizable monomer and the second monofunctional radical polymerizable monomer can be regulated as appropriate. As the ratio of the first monofunctional radical polymerizable monomer is higher, there is a tendency that the elastic modulus and the glass transition temperature of the cured product are lowered, and the elongation at break increases. As the ratio of the second monofunctional radical polymerizable monomer is higher, the elastic modulus and the glass transition temperature of the cured product tend to increase.

It is considered that a monomer unit derived from the first monofunctional radical polymerizable monomer functions, in the cured product, as a soft segment that alleviates external forces such as elongation and folding. Furthermore, it is considered that a monomer unit derived from the second monofunctional radical polymerizable monomer functions, in the cured product, as a hard segment that resists external forces such as elongation and folding. It is contemplated that when these two kinds of monomer units having significantly different characteristics are incorporated into the polymer chain that forms a cured product, a balance can be achieved between the characteristics of the two monomer units. However, the mechanism by which the physical properties of the cured product are manifested is not necessarily limited to this.

The curable resin composition may further comprise a monomer other than the first monofunctional radical polymerizable monomer and the second monofunctional radical polymerizable monomer, as a radical polymerizable monomer. However, the total content of the first monofunctional radical polymerizable monomer and the second monofunctional radical polymerizable monomer may be 60% by mass or more, 70% by mass or more, or 80% by mass or more, based on the total amount of the radical polymerizable monomers. When the total content of the first monofunctional radical polymerizable monomer and the second monofunctional radical polymerizable monomer is within these ranges, a more remarkable effect is obtained from the viewpoint that the cured product has high elongation at break and a high elastic elongation percentage.

The radical polymerizable monomers in the curable resin composition may also include a polyfunctional radical polymerizable monomer having two or more radical polymerizable groups, and/or a monofunctional radical polymerizable monomer other than the first monofunctional radical polymerizable monomer and the second radical polymerizable monomer (monomer that forms, when polymerized alone, a homopolymer of higher than 20° C. and lower than 50° C.).

When the radical polymerizable monomers include a polyfunctional radical polymerizable monomer, the cured product tends to have high strength at break and excellent solvent resistance. The curable resin composition may also include a bifunctional radical polymerizable monomer and/or a trifunctional radical polymerizable monomer, as the polyfunctional radical polymerizable monomer. The content of the polyfunctional radical polymerizable monomer may be 0.01% by mass or more, 0.05% by mass or more, or 0.1% by mass or more, and may be 10% by mass or less, 8.0% by mass or less, or 5.0% by mass or less, based on the total amount of the radical polymerizable monomers. When the content of the polyfunctional radical polymerizable monomer is within these ranges, there is a tendency that a balance can be achieved between the strength at break and the elongation at break of the cured product at a particularly high level.

The polyfunctional radical polymerizable monomer may be a polyfunctional (meth)acrylate, from the viewpoint of compatibility with other components. The polyfunctional (meth)acrylate may be a bifunctional (meth)acrylate and/or a trifunctional (meth)acrylate. By using a bifunctional and/or trifunctional (meth)acrylate, a more advantageous effect is obtained from the viewpoint of achieving a balance between the strength at break and the elongation at break of the cured product. The bifunctional and/or trifunctional (meth)acrylate may contain a cyclic structure, or may form a cyclic structure by a curing reaction.

Examples of the bifunctional or trifunctional (meth)acrylate include 1,3-butylenediol di(meth)acrylate, 1,4-butanediol di(meth)acrylate, 1,6-hexanediol di(meth)acrylate, 1,9-nonanediol di(meth)acrylate, 1,10-decanediol di(meth)acrylate, polyethylene glycol di(meth)acrylate, polypropylene glycol di(meth)acrylate, polytetraethylene glycol di(meth)acrylate, neopentyl glycol di(meth)acrylate, ethoxy-modified bisphenol A di(meth)acrylate, tris(2-(meth)acryloyloxyethyl) isocyanurate, trimethylolpropane tri(meth)acrylate, and pentaerythritol tri(meth)acrylate. These can be used singly or in combination of two or more kinds thereof.

The total content of the bifunctional (meth)acrylate and the trifunctional (meth)acrylate may be 0.1% by mass or more, 0.2% by mass or more, or 0.5% by mass or more, and may be 10% by mass or less, 8.0% by mass or less, or 5.0% by mass or less, based on the total amount of the radical polymerizable monomers.

The curable resin composition may include a radical polymerization initiator for the polymerization of the radical polymerizable monomers. The radical polymerization initiator may be a thermal radical polymerization initiator, a photoradical polymerization initiator, or a combination thereof. The content of the radical polymerization initiator is adjusted as appropriate in a conventional range; however, the content may be, for example, 0.001% to 5% by mass based on the mass of the curable resin composition.

Examples of the thermal radical polymerization initiator include organic peroxides such as a ketone peroxide, a peroxy ketal, a dialkyl peroxide, a diacyl peroxide, a peroxy ester, a peroxy dicarbonate, and a hydroperoxide; persulfates such as sodium persulfate, potassium persulfate, and ammonium persulfate; azo compounds such as 2,2′-azobis-isobutyronitrile (AIBN), 2,2′-azobis-2,4-dimethylvaleronitrile (ADVN), 2,2′-azobis-2-methylbutyronitrile, and 4,4′-azobis-4-cyanovaleric acid; alkyl metals such as sodium ethoxide and tert-butyllithium; and silicon compounds such as 1-methoxy-1-(trimethylsiloxy)-2-methyl-1-propene.

A thermal radical polymerization initiator and a catalyst may also be used in combination. Examples of this catalyst include metal salts; and reducing compounds such as tertiary amine compounds, such as N,N,N′,N′-tetramethylethylenediamine.

Examples of the photoradical polymerization initiator include aromatic ketones such as benzophenone, 2-benzyl-2-dimethylamino-1-(4-morpholinophenyl)-butanone, 1,2-methyl-1-[4-(methylthio)phenyl]-2-morpholinopropanone, and 1,2,2-dimethoxy-1,2-diphenylethan-1-one (Irgacure 651 (manufactured by Ciba-Geigy Japan, Ltd.); quinone compounds such as an alkylanthraquinone; benzoin ether compounds such as a benzoin alkyl ether; benzoin compounds such as benzoin and an alkylbenzoin; benzyl derivatives such as benzyl dimethyl ketal; a 2,4,5-triarylimidazole dimers such as 2-(2-chlorophenyl)-4,5-diphenylimidazole dimer and a 2-(2-fluorophenyl)-4,5-diphenylimidazole dimer; and acridine derivatives such as 9-phenylacridine and 1,7-(9,9′-acridinyl)heptane. The photopolymerization initiators can be used singly or in combination of two or more kinds thereof.

The curable resin composition may also include, if necessary, a binder polymer, a solvent, a photocolor developer, a thermal color development inhibitor, a plasticizer, a pigment, a filler, a flame retardant, a stabilizer, a tackifier, a leveling agent, a peeling accelerator, an oxidation inhibitor, a fragrance, an imaging agent, a thermal crosslinking agent, and the like. These can be used singly or in combination of two or more kinds thereof. In a case in which the curable resin composition includes those other components, the content of the other components may be 0.01% by mass or more, and may be 20% by mass or less, based on the mass of the photocurable resin composition.

The cured product can be produced by a method including a step of radical-polymerizing the radical polymerizable monomers in the curable resin composition and thereby curing the curable resin composition. Radical polymerization of the radical polymerizable monomers can be initiated by heating or irradiation with active light rays such as ultraviolet radiation.

In regard to radical polymerization, generally, there is a tendency that a polymer having a high molecular weight is obtained by lowering the rate of radical generation caused by decomposition of the radical polymerization initiator. The rate of radical generation can be controlled by means of the radical polymerization conditions. There are methods such as reducing the amount of the radical polymerization initiator into a small amount, lowering the heating temperature in thermal radical polymerization, and lowering the illuminance of active light rays in photoradical polymerization.

The conditions for radical polymerization for curing the curable resin composition are not particularly limited; however, the conditions can be set in view of the circumstances described above. The temperature for thermal radical polymerization may be, for example, within plus or minus 10° C. of the decomposition temperature of the radical polymerization initiator. In a case in which the curable resin composition includes a solvent, this temperature may be lower than or equal to the boiling point of the solvent. The illuminance of photoradical polymerization may be, for example, 1 mW/cm² or lower. As the molecular weight of the polymer thus formed is larger, the elongation at break of the cured product tends to increase, and a balance may be easily achieved between high elastic modulus and high elongation at break.

The radical polymerization reaction can be carried out in an atmosphere of an inert gas such as nitrogen gas, helium gas, or argon gas. Thereby, polymerization inhibition caused by oxygen is suppressed, and a cured product having satisfactory product quality can be stably obtained.

The glass transition temperature of the cured product is not particularly limited; however, for example, the glass transition temperature may be 30° C. or higher, or may be 40° C. or higher. When the glass transition temperature is higher than or equal to room temperature or the use temperature, a high elastic modulus is likely to be maintained at the time of use, and it is advantageous in view of having excellent handleability. The glass transition temperature can be regulated by, for example, the mixing ratio between the first monofunctional radical polymerizable monomer and the second monofunctional radical polymerizable monomer in the curable resin composition.

The elastic modulus (tensile modulus) of the cured product may be 10 MPa or higher, 100 MPa or higher, or 200 MPa or higher, and may be 10 GPa or lower, 7 GPa or lower, or 5 GPa or lower. When the elastic modulus of the cured product is within the range described above, there is a tendency that a balance between the elongation at break and the elastic elongation percentage may be easily achieved. The elastic modulus can be regulated by, for example, the mixing ratio between the first monofunctional radical polymerizable monomer and the second monofunctional radical polymerizable monomer in the curable resin composition.

The elongation at break of the cured product may be 10% or higher, 100% or higher, or 200% or higher. When the elongation at break of the cured product is in the above-mentioned range, the extent of restorable shape change is large, and a particularly remarkable effect is obtained from the viewpoint of characteristics such as folding resistance.

The strength at break of the cured product may be 1 MPa or higher, 3 MPa or higher, or 5 MPa or higher.

The weight average molecular weight of the polymer that forms the cured product (polymer of the radical polymerizable monomers) may be 100,000 or more, or 200,000 or more. As the weight average molecular weight is larger, the elongation at break tends to increase. In the present specification, unless particularly defined otherwise, the weight average molecular weight means a value determined by gel permeation chromatography and calculated relative to polystyrene standards.

A cured product having excellent shape restorability after being deformed under stress has a high elastic elongation percentage. The elastic elongation percentage of the cured product may be 60% or higher, 70% or higher, or 80% or higher, and may be 1,000% or lower.

The elastic elongation percentage is measured by, for example, the following procedure.

(1) A specimen of a cured product having a size of 5 mm×50 mm is prepared, and marks are made at three sites along the longitudinal direction in an area corresponding to the chuck distance. The distances between the various marks are designated as L0 and L0′.

(2) A tensile test is performed with a tensile testing machine under the conditions of a measurement temperature of 25° C., a tensile rate of 10 mm/min, and a distance between chucks L1 of 30 mm.

(3) For the specimen obtained immediately after fracture, marks at two points where there is no site of fracture between marks are selected from among the three marks, and the distance between those marks L2 is measured. In a case in which the initial length corresponding to this portion is L0, the elongation at break is calculated by formula: (L2−L0)/L0. In a case in which the initial length is L0′, the elongation at break is calculated by formula: (L2−L0′)/L0′. Alternatively, the elongation at break may also be calculated by formula: (L3−L1)/L1, using the distance between chucks L3 at the time of fracture.

(4) The specimen after fracture is heated for 3 minutes at 70° C., and the distance between marks L4 after heating is measured. The elastic elongation percentage, which represents the proportion of elastic elongation with respect to the elongation at break, is calculated by formula: (L2−L4)/(L2−L0). The distance L2 immediately after fracture may be calculated by formula: L2=L3×(L0/L1), by utilizing the distance between chucks L3.

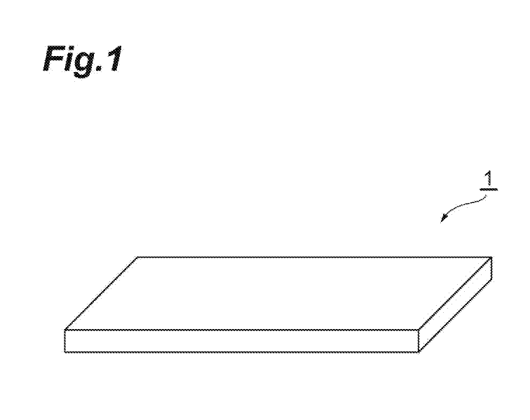

There are no particular limitations on the shape and size of the cured product (resin molded article). For example, a cured product having an arbitrary shape can be obtained by curing a curable resin composition that is filled in a predetermined mold. The cured product may have, for example, a fibrous shape, a rod shape, a columnar shape, a cylindrical shape, a flat plate shape, a disc shape, a helical shape, a spherical shape, or a ring shape. The cured product may also be further processed by various methods such as machine processing and melt molding. FIG. 1 is a perspective view illustrating an embodiment of a resin molded article. Resin molded article 1 of FIG. 1 is an example of a flat plate-shaped molded article.

Composition for Molding

A composition for molding according to an embodiment comprises radical polymerizable monomers including a radical polymerizable compound represented by Formula (I):

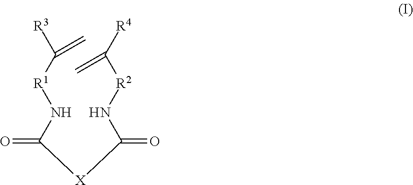

and a monofunctional radical polymerizable monomer; and a second polymer. In Formula (I), X, R¹, and R² each independently represent a divalent organic group; and R³ and R⁴ each independently represent a hydrogen atom or a methyl group. When the radical polymerizable monomers are polymerized in the composition for molding, a first polymer composed of monomer units derived from those radical polymerizable monomers is produced. Thereby, the reaction product is cured, and a resin molded article (cured article) is formed. The first polymer is usually formed as a polymer separate from the second polymer in the molded article, without being bonded to the second polymer by covalent bonding.

The first polymer can contain a cyclic monomer unit represented by the following Formula (II), which is derived from the compound of Formula (I). It is considered that the cyclic monomer unit of Formula (II) contributes to the manifestation of unique characteristics such as shape memory properties of the resin molded article. However, it is not necessarily essential for the first polymer to contain the monomer unit of Formula (II).

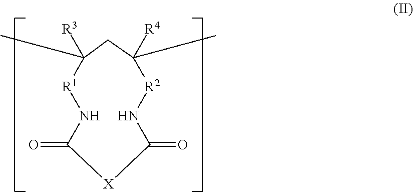

X in Formulae (I) and (II) may also be, for example, a group represented by the following Formula (10):

*—Z¹—(CH₂)ᵢ—Y—(CH₂)ⱼ—Z²—* (10)

In Formula (10), Y represents a cyclic group which may have a substituent; Z¹ and Z² each independently represent a functional group containing an atom selected from a carbon atom, an oxygen atom, a nitrogen atom, and a sulfur atom; and i and j each independently represent an integer from 0 to 2. The symbol * represents a linking point (this is also the same for other formulae). It is considered that when X represents a group of Formula (10), the cyclic monomer unit of Formula (II) may be particularly easily formed. The configuration of Z¹ and Z² with respect to the cyclic group Y may be the cis-position or may be the trans-position. Z¹ and Z² may also be groups represented by —O—, —OC(═O)—, —S—, —SC(═O)—, —OC(═S)—, —NR¹⁰— (wherein R¹⁰ represents a hydrogen atom or an alkyl group), or —ONH—.

Y may be a cyclic group having 2 to 10 carbon atoms, and may also contain a heteroatom selected from an oxygen atom, a nitrogen atom, and a sulfur atom. This cyclic group Y may be, for example, an alicyclic group, a cyclic ether group, a cyclic amine group, a cyclic thioether group, a cyclic ester group, a cyclic amide group, a cyclic thioester group, an aromatic hydrocarbon group, a heteroaromatic hydrocarbon group, or a combination thereof. The cyclic ether group may be a cyclic group carried by a monosaccharide or a polysaccharide. Specific examples of Y include, but are not particularly limited to, cyclic groups represented by the following Formulae (11), (12), (13), (14), and (15). From the viewpoint of stress relaxation characteristics of the resin molded article, Y may also be a group of Formula (II) (particularly, a 1,2-cyclohexanediyl group).

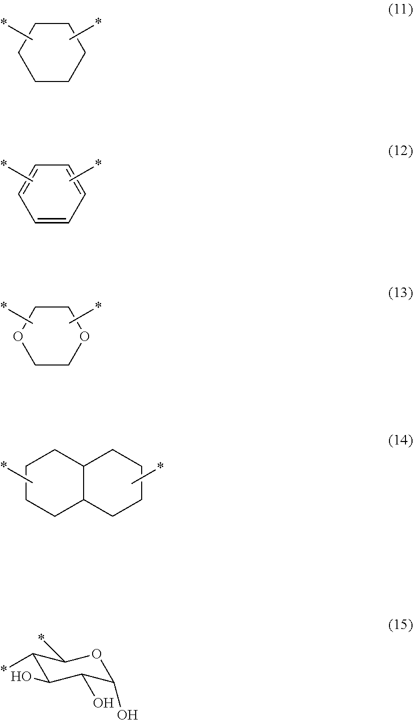

R¹ and R² in Formulae (I) and (II) may be identical with or different from each other, and may each represent a group represented by the following Formula (20).

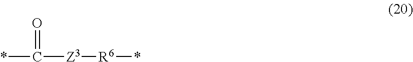

In Formula (20), R⁶ represents a hydrocarbon group (alkylene group or the like) having 1 to 8 carbon atoms and is bonded to a nitrogen atom in Formula (I) or (II). Z³ represents a group represented by —O— or —NR¹⁰— (wherein R¹⁰ represents a hydrogen atom or an alkyl group). It is considered that when R¹ and R² both represent a group of Formula (20), a cyclic monomer unit of Formula (II) may be particularly easily formed. The number of carbon atoms of R⁶ may be 2 or more and may be 6 or less, or 4 or less.

One specific example of the radical polymerizable compound of Formula (I) is a compound represented by the following Formula (Ia). Here, Y, Z¹, Z², i, and j have the same definitions as Y, Z¹, Z², i, and j of Formula (10), respectively.

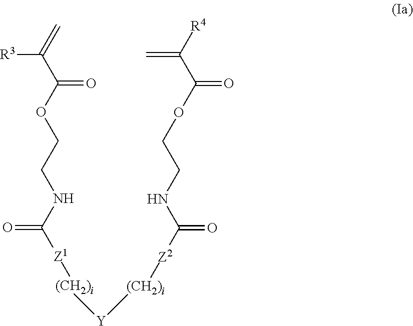

Examples of the compound of Formula (Ia) include compounds represented by the following Formulae (I-1), (I-2), (I-3), (I-4), (I-5), (I-6), (I-7), or (I-8).

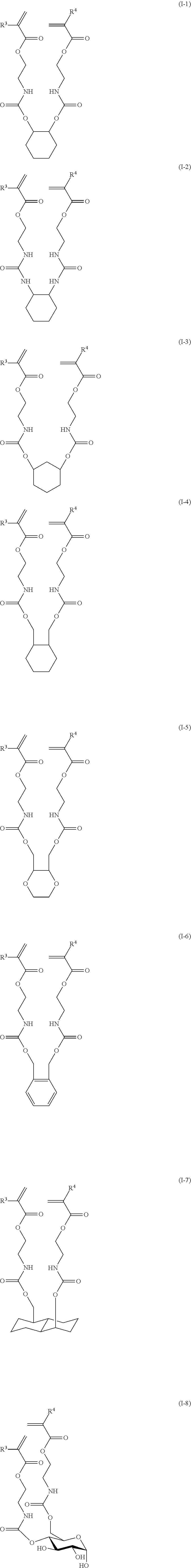

The compounds listed above as examples can be used singly or in combination of two or more kinds thereof.

The proportion of the radical polymerizable compound of Formula (I) in the composition for molding may be 0.01 mol % or more, 0.1 mol % or more, or 0.5 mol % or more, and may be 10 mol % or less, 5 mol % or less, or 1 mol % or less, based on the total amount of the radical polymerizable monomers. When the proportion of the radical polymerizable compound of Formula (I) is within these ranges, a more advantageous effect is obtained from the viewpoint that a cured article having excellent mechanical characteristics such as elongation, strength, and folding resistance is obtained.

The compound of Formula (I) can be synthesized by a conventional synthesis method by using conventionally available raw materials as starting materials, as will be understood by those ordinarily skilled in the art. For example, a compound of Formula (I) can be synthesized by a reaction between a cyclic diol compound or a cyclic diamine compound and a compound having a (meth)acryloyl group and an isocyanate group.

The radical polymerizable monomers in the composition for molding may include an alkyl (meth)acrylate and/or acrylonitrile as a monofunctional radical polymerizable monomer.

The alkyl (meth)acrylate may be an alkyl (meth)acrylate having an alkyl group with 1 to 16 carbon atoms which may have a substituent (an ester between (meth)acrylic acid and an alkyl alcohol having 1 to 16 carbon atoms which may have a substituent). The substituent that may be carried by the alkyl (meth)acrylate having an alkyl group with 1 to 16 carbon atoms may contain an oxygen atom and/or a nitrogen atom.

When the radical polymerizable monomers include an alkyl (meth)acrylate having an alkyl group with 1 to 16 carbon atoms, advantageous effects that the elastic modulus, glass transition temperature (Tg), and mechanical characteristics such as elongation and strength, of the cured article can be controlled, are obtained.

The proportion of the alkyl (meth)acrylate having 1 to 16 carbon atoms which may have a substituent, in the composition for molding may be 10 mol % or more, 15 mol % or more, or 20 mol % or more, and may be 95 mol % or less, 90 mol % or less, or 85 mol % or less, based on the total amount of the radical polymerizable monomers. When the proportion of the alkyl (meth)acrylate having 1 to 16 carbon atoms which may have a substituent is within these ranges, a more advantageous effect is obtained from the viewpoint of obtaining a cured article having excellent mechanical characteristics such as elongation and strength and excellent folding resistance.

When an alkyl (meth)acrylate having an alkyl group with a small number of carbon atoms is used, there is a tendency that the elastic modulus of the resin molded article obtainable after curing increases, and shape memory properties are easily manifested. From such a viewpoint, the radical polymerizable monomers may include an alkyl (meth)acrylate having an alkyl group with 10 or fewer carbon atoms which may have a substituent, as a monofunctional radical polymerizable monomer. The proportion of the alkyl (meth)acrylate having 10 or fewer carbon atoms which may have a substituent, may be 8 mol % or more, 10 mol % or more, or 15 mol % or more, and may be 55 mol % or less, 45 mol % or less, or 25 mol % or less, based on the total amount of the radical polymerizable monomers. When the proportion of the alkyl (meth)acrylate having an alkyl group with 10 or fewer carbon atoms which may have a substituent is within these ranges, a more advantageous effect is obtained from the viewpoint that a resin molded article having an elastic modulus that is high to a certain extent and having shape memory properties may be easily formed. From a similar point of view, the radical polymerizable monomers may also include a (meth)acrylate having an alkyl group with 8 or fewer carbon atoms which may have a substituent, and the proportion of the (meth)acrylate may be in the numerical ranges described above.

Examples of the alkyl (meth)acrylate having 1 to 16 carbon atoms which may have a substituent include ethyl acrylate, ethyl methacrylate, n-butyl acrylate, n-butyl methacrylate, isobutyl acrylate, isobutyl methacrylate, hexyl acrylate, hexyl methacrylate, 2-ethylhexyl acrylate (EHA), 2-ethylhexyl methacrylate, 2-hydroxyethyl methacrylate, 2-hydroxypropyl methacrylate, 2-hydroxy-1-methylethyl methacrylate, 2-methoxyethyl acrylate (MEA), N,N-dimethylaminoethyl acrylate, and glycidyl methacrylate. These can be used singly or in combination of two or more kinds thereof.

When the radical polymerizable monomers include acrylonitrile, there is a tendency that a resin molded article that has excellent mechanical characteristics such as elongation and strength and excellent folding resistance, has an elastic modulus that is high to a certain extent, and has shape memory properties is easily formed. A combination of acrylonitrile and a (meth)acrylate having an alkyl group with 1 to 16 (or 1 to 10) carbon atoms is particularly advantageous for obtaining a resin molded article having a high elastic modulus. The proportion of acrylonitrile in the composition for molding may be 40 mol % or more, 50 mol % or more, or 70 mol % or more, and may be 90 mol % or less, 85 mol % or less, or 80 mol % or less, based on the total amount of the radical polymerizable monomers. When the proportion of acrylonitrile is within these ranges, a more advantageous effect is obtained in view of having rapid shape restoration.

The radical polymerizable monomers may also include one kind or two or more kinds of compounds selected from a vinyl ether, styrene, and a styrene derivative as a monofunctional radical polymerizable monomer. Examples of the vinyl ether include vinyl butyl ether, vinyl octyl ether, vinyl-2-chloroethyl ether, vinyl isobutyl ether, vinyl dodecyl ether, vinyl octadecyl ether, vinyl phenyl ether, and vinyl cresyl ether. Examples of the styrene derivative include an alkylstyrene, an alkoxystyrene (α-methoxystyrene, p-methoxystyrene, or the like), and m-chlorostyrene.

The radical polymerizable monomers may also include another monofunctional radical polymerizable monomer and/or a polyfunctional radical polymerizable monomer. Examples of the other monofunctional radical polymerizable monomer include vinyl phenol, N-vinylcarbazole, 2-vinyl-5-ethylpyridine, isopropenyl acetate, vinyl isocyanate, vinyl isobutyl sulfide, 2-chloro-3-hydroxypropene, vinyl stearate, p-vinyl benzyl ethyl carbinol, vinyl phenyl sulfide, allyl acrylate, α-chloroethyl acrylate, allyl acetate, 2,2,6,6-tetramethyl piperidinyl methacrylate, N,N-diethyl vinyl carbamate, vinyl isopropenyl ketone, N-vinyl caprolactone, vinyl formate, p-vinyl benzyl methyl carbinol, vinyl ethyl sulfide, vinylferrocene, vinyl dichloroacetate, N-vinylsuccinimide, allyl alcohol, norbornadiene, diallyl melamine, vinyl chloroacetate, N-vinylpyrrolidone, vinyl methyl sulfide, N-vinyloxazolidine, vinyl methyl sulfoxide, N-vinyl-N′-ethylurea, and acenaphthalene.

The various radical polymerizable monomers listed above as examples can be used singly or in combination of two or more kinds thereof.

The composition for molding includes the radical polymerizable monomers explained above, and a linear or branched second polymer. The second polymer may be a polymer containing two or more linear chains and linking groups that connect the terminals of the linear chains. This polymer contains, for example, a molecular chain represented by the following Formula (B). In Formula (B), R²⁰ represents a monomer unit that constitutes a linear chain; n¹, n², and n³ each independently represent an integer of 1 or greater; and L represents a linking group. A plurality of R²⁰'s and a plurality of L's in the same molecule may be respectively identical or different.

*R²⁰ₙ_{¹}LR²⁰ₙ_{²}LR²⁰ₙ_{³}* (B)

The linear chain composed of the monomer unit R²⁰ may be a molecular chain derived from a polyether, a polyester, a polyolefin, a polyorganosiloxane, or a combination thereof. The respective linear chains may be polymers, or may be oligomers.

Examples of a linear chain derived from a polyether include polyoxyalkylene chains such as a polyoxyethylene chain, a polyoxypropylene chain, a polyoxybutylene chain, and combinations thereof. The polyoxyethylene chain is derived from a polyether such as a polyalkylene glycol. Examples of a linear chain derived from a polyolefin include a polyethylene chain, a polypropylene chain, a polyisobutylene chain, and combinations thereof. Examples of a linear chain derived from a polyester include a poly-ε-caprolactone chain. Examples of a linear chain derived from a polyorganosiloxane include a polydimethylsiloxane chain. The second polymer may contain these singly or a combination of two or more kinds selected from these.

The number average molecular weight of each of the linear molecular chains that constitute the second polymer is not particularly limited; however, the number average molecular weight may be, for example, 1,000 or more, 3,000 or more, or 5,000 or more, and may be 80,000 or less, 50,000 or less, or 20,000 or less. According to the present specification, unless particularly defined otherwise, the number average molecular weight means a value that is determined by gel permeation chromatography and calculated relative to polystyrene standards.

The linking group L is an organic group containing a cyclic group, or a branched organic group. The linking group L may also be, for example, a divalent group represented by the following Formula (30).

*—Z⁵—R³⁰—Z⁶—* (30)

R³⁰ represents a cyclic group; a group containing two or more cyclic groups linked to each other directly or via an alkylene group; or a branched organic group that contains carbon atoms and may contain a heteroatom selected from an oxygen atom, a nitrogen atom, a sulfur atom, and a silicon atom. Z⁵ and Z⁶ each represent a divalent group that links R³⁰ to a linear chain, and represents a group represented by, for example, —NHC(═O)—, —NHC(═O)O—, —O—, —OC(═O)—, —S—, —SC(═O)—, —OC(═S)—, or —NR¹⁰— (wherein R¹⁰ represents a hydrogen atom or an alkyl group). According to the present specification, the terminal atoms of the linear chain (atoms originating from a monomer that constitutes the linear chain) are usually not construed as atoms that constitute Z⁵ or Z⁶. In a case in which it is not clear whether the terminal atoms of the linear chain are atoms originating from a monomer, the atoms may be construed to be included in any of a linear chain and a linking group.

The cyclic group contained in the linking group L may contain a heteroatom selected from a nitrogen atom and a sulfur atom. The cyclic group contained in the linking group L may be an alicyclic group, a cyclic ether group, a cyclic amine group, a cyclic thioether group, a cyclic ester group, a cyclic amide group, a cyclic thioester group, an aromatic hydrocarbon group, a heteroaromatic hydrocarbon group, or a combination thereof. Specific examples of the cyclic group contained in the linking group L include a 1,4-cyclohexanediyl group, a 1,2-cyclohexanediyl group, a 1,3-cyclohexanediyl group, a 1,4-benzenediyl group, a 1,3-benzenediyl group, a 1,2-benzenediyl group, and a 3,4-furandiyl group.

Examples of the branched organic group contained in the linking group L (for example, R³⁰ in Formula (30)) include a lysinetriyl group, a methylsilanetriyl group, and a 1,3,5-cyclohexanetriyl group.

The linking group L represented by Formula (30) may be a group represented by the following Formula (31). R³¹ in Formula (31) represents a single bond or an alkylene group. R³¹ may also be an alkylene group having 1 to 3 carbon atoms. Z⁵ and Z⁶ have the same definitions as Z⁵ and Z⁶ of Formula (30), respectively.

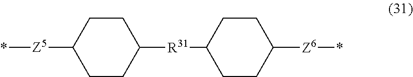

The weight average molecular weight of the second polymer is not particularly limited; however, for example, the weight average molecular weight may be 5,000 or more, 7,000 or more, or 9,000 or more, and may be 100,000 or less, 80,000 or less, or 60,000 or less. When the weight average molecular weight of the second polymer is within these numerical ranges, there is a tendency that satisfactory compatibility with components other than the second polymer and satisfactory general characteristics of the resin molded article are easily obtained.

As will be understood by those ordinarily skilled in the art, the second polymer can be obtained by a conventional synthesis method by using conventionally available raw materials as starting materials. For example, the second polymer can be synthesized by a reaction between a mixture including a polyalkylene glycol, a polyester, a polyolefin, a polyorganosiloxane, which have reactive terminal groups (hydroxyl groups or the like), or a combination thereof, and a compound having a reactive functional group (an isocyanate group or the like) and a cyclic group or a branched group. The second polymer to be synthesized may also include a branched structure based on a side reaction such as trimerization of isocyanate groups.

The composition for molding may also include a polymerization initiator for polymerizing the radical polymerizable monomers. The polymerization initiator may be a thermal radical polymerization initiator, a photoradical polymerization initiator, or a combination thereof. The content of the polymerization initiator may be adjusted as appropriate in a conventional range; however, the content may be, for example, 0.01% to 5% by mass based on the mass of the composition for molding.

Examples of the thermal radical polymerization initiator include organic peroxides such as a ketone peroxide, a peroxy ketal, a dialkyl peroxide, a diacyl peroxide, a peroxy ester, a peroxy dicarbonate, and a hydroperoxide; persulfates such as sodium persulfate, potassium persulfate, and ammonium persulfate; azo compounds such as 2,2′-azobisisobutyronitrile (AIBN), 2,2′-azobis-2,4-dimethylvaleronitrile (ADVN), 2,2′-azobis-2-methylbutyronitrile, and 4,4′-azobis-4-cyanovaleric acid; alkyl metals such as sodium ethoxide and tert-butyllithium; and silicon compounds such as 1-methoxy-1-(trimethylsiloxy)-2-methyl-1-propene.

A thermal radical polymerization initiator and a catalyst may also be used in combination. Examples of this catalyst include metal salts, and reducing compounds such as a tertiary amine compound, such as N,N,N′,N′-tetramethylethylenediamine.

Examples of the photoradical polymerization initiator include 2,2-dimethoxy-1,2-diphenylethan-1-one. Commercially available products thereof include Irgacure 651 (manufactured by Ciba-Geigy Japan, Ltd.).

The composition for molding may include a solvent or may be substantially solvent-free. The composition for molding may be in any of a liquid form, a semisolid form, and a solid form. The composition for molding before being cured may be in a film form.

The resin molded article can be produced by a method including a step of producing a first polymer by radical polymerization of the radical polymerizable monomers in the composition for molding. Radical polymerization of the radical polymerizable monomers can be initiated by heating, or irradiation with active rays such as ultraviolet radiation.

The shape and size of the resin molded article (cured article) are not particularly limited, and for example, a resin molded article having an arbitrary shape can be obtained by curing the composition for molding that has been filled in a predetermined mold. The resin molded article may have, for example, a fibrous shape, a rod shape, a columnar shape, a cylindrical shape, a flat plate shape, a disc shape, a helical shape, a spherical shape, or a ring shape. The molded article obtained after curing may also be further processed by various methods such as machine processing.

The temperature of the polymerization reaction is not particularly limited; however, in a case in which the composition for molding includes a solvent, it is preferable that the temperature is lower than or equal to the boiling point of the solvent. It is preferable that the polymerization reaction is carried out in an atmosphere of an inert gas such as nitrogen gas, helium gas, or argon gas. Thereby, polymerization inhibition by oxygen is suppressed, and a molded article having satisfactory product quality can be stably obtained.

It is considered that when the radical polymerizable monomers including the radical polymerizable compound of Formula (I) are polymerized, cyclic monomer units of Formula (II) are formed. When the radical polymerizable monomers are polymerized in the presence of the first polymer, a structure in which the second polymer penetrates through the cyclic moiety in at least a portion of the cyclic monomer units of Formula (II) may be formed. The following Formula (III) schematically represents a structure in which the second polymer (B) penetrates through a cyclic moiety of a monomer unit of Formula (II) contained in the first polymer (A). R⁵ in Formula (III) is a monomer unit derived from a radical polymerizable monomer other than the radical polymerizable compound of Formula (I). When a structure such as Formula (III) is formed, a crosslinked network structure like a three-dimensional copolymer is formed by the first polymer and the second polymer. In this network structure, it is considered that the degree of freedom in motion of the second polymer that penetrates through a cyclic moiety is maintained at a relatively high level. Such a structure may be referred to as a slide-ring structure by those ordinarily skilled in the art, and the inventors of the present invention speculate that this slide-ring structure contributes to the manifestation of unique characteristics such as the shape memory properties of the resin molded article. It is not technically easy to directly confirm that a slide-ring structure has been formed; however, for example, since the stress-strain curve obtained by a tensile test of the resin molded article is a so-called J-shaped curve, formation of the slide-ring structure is suggested. However, the resin molded article may not necessarily contain such a slide-ring structure.

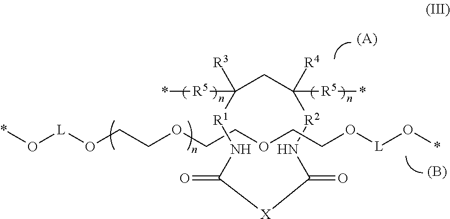

In the example of Formula (III), the second polymer (B) has a plurality of polyoxyethylene chain and a linking group L that connects a terminals of the polyoxyethylene chains. Since the linking group L is bulky compared to a polyoxyethylene chain, the state in which the second polymer penetrates through a cyclic moiety of the monomer unit of Formula (II) can be easily maintained, as in the case of a polyrotaxane. The second polymer can be selected as appropriate based on the balance in the size, inclusion ability, and the like of the cyclic monomer unit, and the characteristics of polyrotaxanes.

Although a resin molded article in which the first polymer has been produced and cured may have or may not have shape memory properties, a resin molded article having shape memory properties can be obtained by appropriately selecting the kinds of the radical polymerizable monomers. According to the present specification, the “shape memory properties” mean properties by which, when a resin molded article is deformed by an external force at room temperature (for example, 25° C.), the resin molded article retains the shape after deformation at room temperature and restores the original shape when heated to a high temperature under no-load conditions. However, the resin molded article may not perfectly restore the same shape as the original shape as a result of heating. The temperature of heating for shape restoration is, for example, 70° C.

In a case in which a cured resin molded article has shape memory properties, usually, the shape of the resin molded article possessed at the time point at which a first polymer is produced and cured becomes a basic shape. The resin molded article that has been deformed by an external force is deformed so as to approach this basic shape as a result of heating. By curing the resin molded article inside a mold having a predetermined shape, a resin molded article having a desired shape as the basic shape can be obtained.

The storage modulus at 25° C. of the resin molded article is not particularly limited; however, the storage modulus may be 0.5 MPa or higher. A resin molded article having a storage modulus of 0.5 MPa or higher typically has shape memory properties. The elastic modulus of the resin molded article may be 1.0 MPa or higher, or 10 MPa or higher, and may be 10 GPa or lower, 5 GPa or lower, or 500 MPa or lower. As the storage modulus is higher, the resin molded article tends to easily retain the shape after deformation. When the resin molded article has a storage modulus of an appropriate magnitude, the resin molded article tends to easily restore the original shape at the time of heating. The elastic modulus of the resin molded article can be controlled based on, for example, the kinds and mixing ratios of the radical polymerizable monomers, the molecular weight of the second polymer, and the amount of the radical polymerization initiator.

### EXAMPLES

Hereinafter, the present invention will be more specifically described by way of Examples. However, the present invention is not intended to be limited to these Examples.

Curable Resin Composition

1. Curable Resin Composition

A curable resin composition was produced by mixing various raw materials at the mass ratio indicated in Table 1. The values in the table represent parts by mass.

2. Production of Cured Product Film

The resulting curable resin composition was dropped on a polyethylene terephthalate (PET) film that had been subjected to a release treatment, and thereby a coating film of the curable resin composition was formed. The coating film was covered with a PET film that had been subjected to a release treatment, while leaving a gap of 0.2 mm with the coating film. The coating film was cured by irradiating the coating film with ultraviolet radiation at 365 nm from above the PET film in a cumulative amount of light of 1,000 mJ/cm², and thus a cured product film was formed.

In Comparative Example 1, a self-sustaining cured product film to be supplied for the evaluation could not be obtained, and various measurements could not be carried out. In Comparative Example 2, the cured product underwent phase separation and did not form a film, and various measurements could not be carried out.

3. Measurement of Elongation at Beak, Elastic Elongation Percentage, Strength at Break, and Tensile Modulus

A specimen having a size of 5 mm×50 mm was punched out from the cured product film. In an area of the specimen corresponding to the chuck distance, marks were made with an oily marker at three sites along the longitudinal direction, and the distances between the various marks were designated as L0 and L0′. A tensile test was performed with a tensile testing machine (manufactured by Shimadzu Corp., EZ-TEST) under the conditions of a measurement temperature of 25° C., a tensile rate of 10 mm/min, and a distance between chucks L1 of 30 mm. For the specimen obtained immediately after fracture, marks at two points where there was no site of fracture between marks were selected from among the three marks, and the distance between those marks L2 was measured. In a case in which the initial length corresponding to this portion was L0, the elongation at break was calculated by formula: (L2−L0)/L0. Alternatively, the elongation at break may also be calculated by formula: (L3−L1)/L1, using the distance between chucks L3 at the time of fracture.

The specimen after fracture was heated for 3 minutes at 70° C., and the distance between marks L4 after heating was measured. The elastic elongation percentage, which represents the proportion of elastic elongation with respect to the elongation at break, was calculated by formula: (L2−L4)/(L2−L0). The distance L2 immediately after fracture may be calculated by formula: L2=L3×(L0/L1), by utilizing the distance between chucks L3. The stress at the time of fracture as designated as strength at break, and the gradient of a stress-strain curve in the early stage of stretching was designated as tensile modulus.

4. Observation of Folding Resistance

The cured product film (50 mm×50 mm×0.2 mm) was folded two times, and while in that state, a pressure of 1 N/cm² was applied perpendicularly to the folds for 5 minutes. The fold portions were restored to the original state, and then those portions were observed by visual inspection and with an optical microscope (10 times). A case in which any change in the external appearance and abnormalities such as whitening and voids were not recognized compared to the state before folding was considered as “good”, and a case in which whitening or voids were recognized was considered as “defective”.

5. Measurement of Glass Transition Temperature

A short strip-shaped specimen having a width of 5 mm and a length of 50 mm was cut out from the cured product film. After a PET film was peeled off from the specimen, temperature change of tan δ was measured with a dynamic viscoelasticity analyzer (RSA-G2) manufactured by TA Instruments, Inc., under the conditions of a distance between chucks of 20 mm and a measurement frequency of 10 Hz. The temperature at which tan δ had a peak value was designated as glass transition temperature.

TABLE 1

| | | | | | | Comparative | | |
|---|---|---|---|---|---|---|---|---|
| | | Example | | | | Example | | |
| | | 1 | 2 | 3 | 4 | 1 | 2 | 3 |
| First | 2-Ethylhexyl | 48 | 78 | 38 | 55 | 96 | — | — |
| monofunctional | acrylate | | | | | | | |
| radical | | | | | | | | |
| polymerizable | | | | | | | | |
| monomer | | | | | | | | |
| Second | Acrylonitrile | 48 | — | — | 41 | — | 96 | — |
| monofunctional | Dicyclopentanyl | — | 19 | — | — | — | — | 96 |
| radical | acrylate | | | | | | | |
| polymerizable | Methyl | — | — | 58 | — | — | — | — |
| monomer | methacrylate | | | | | | | |
| Bifunctional | 1,9-Bis(acryloyloxy)nonane | 2 | — | 2 | 2 | 2 | 2 | 2 |
| radical | | | | | | | | |
| polymerizable | | | | | | | | |
| monomer | | | | | | | | |
| First radical polymerizable | | 49 | 80 | 41 | 56 | 98 | 0 | 0 |
| monomer content (mass %) | | | | | | | | |
| Second radical polymerizable | | 49 | 20 | 57 | 42 | 0 | 98 | 98 |
| monomer content (mass %) | | | | | | | | |
| Photoradical | Irgacure 651 | 3 | 3 | 3 | 3 | 3 | 3 | 3 |
| polymerization | | | | | | | | |
| initiator | | | | | | | | |

| | | | | | | | |
|---|---|---|---|---|---|---|---|
| Elongation at break (%) | 310 | 410 | 210 | 400 | — | — | 10 |
| Strength at break (MPa) | 31 | 11 | 8 | 24 | — | — | 20 |
| Tensile modulus (MPa) | 540 | 480 | 120 | 160 | — | — | 1000 |
| Elastic elongation percentage (%) | 96 | 92 | 95 | 90 | — | — | 20 |
| Folding resistance | Good | Good | Good | Good | — | — | Defective |
| Glass transition temperature (° C.) | 60 | 60 | 50 | 40 | — | — | 120 |

It was confirmed that the curable resin composition of the Examples containing the first radical polymerizable monomer and the second radical polymerizable monomer can form a resin molded article having high elongation at break and also having excellent shape restorability after being deformed under stress, compared to the curable resin composition of Comparative Example 3.

Composition for Molding

### 1. Synthesis

### Synthesis Example 1: Synthesis of trans-1,2-bis(2-acryloyloxyethylcarbamoyloxy)cyclohexane (BACH)

Trans-1,2-cyclohexanediol (2.32 g, 20.0 mmol) was introduced into a 100-mL double-necked pear-shaped flask, and the interior of the flask was purged with nitrogen. Dichloromethane (40 mL) and dibutyltin dilaurate (11.8 μL, 0.10 mol %: 0.020 mmol) were introduced into the flask. To the reaction liquid in the flask, a dichloromethane (4 mL) solution of 2-acryloyloxyethyl isocyanate (5.93 g, 42.0 mmol) was added dropwise from a dropping funnel, and the reaction liquid was stirred for 24 hours at 30° C. to cause a reaction to proceed. After completion of the reaction, diethyl ether was added to the reaction liquid, and the mixture was washed with saturated brine. The organic layer was dried over anhydrous magnesium sulfate, and then the solvent was distilled off under reduced pressure. A solution containing the intended product was isolated from the residue by silica gel chromatography (developing solvent: chloroform), and the solution was concentrated. A crude product thus obtained was purified by recrystallization from diethyl ether and hexane, and thus white crystals of BACH were obtained. The yield amount was 3.78 g, and the yield percentage was 47.4% by mass.

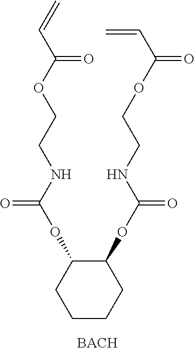 [SMILES: C=CC(=O)OCCNC(=O)O[C@H]1CCCC[C@@H]1OC(=O)NCCOC(=O)C=C]

### Synthesis Example 2: Synthesis of PEG-PPG Oligomer 1

A polyethylene glycol (PEG1500, 750 mg, 0.500 mmol, number average molecular weight 1,500) and a polypropylene glycol (PPG4000, 2,000 mg, 0.500 mmol, number average molecular weight 4,000) were added to a 20-mL pear-shaped flask, and then the interior of the flask was purged with nitrogen. The content was melted at 115° C. 4,4′-Dicyclohexylmethane diisocyanate (262 mg, 1.00 mmol) was added to the molten liquid, and the molten liquid was stirred for 24 hours at 115° C. in a nitrogen atmosphere. Thus, PEG-PPG Oligomer 1 (second polymer containing polyoxyethylene chains and polyoxypropylene chains) was obtained.

The weight average molecular weight (Mw) of resulting Oligomer 1 was 9,300, and the weight average molecular weight/number average molecular weight (Mw/Mn) of Oligomer 1 was 1.65.

### Synthesis Example 3: Synthesis of PEG-PPG Oligomer 2

A polyethylene glycol (PEG1500, 750 mg, 0.500 mmol, number average molecular weight 1,500) and a polypropylene glycol (PPG4000, 2,000 mg, 0.500 mmol, number average molecular weight 4,000) were added to a 20-mL pear-shaped flask, and then the interior of the flask was purged with nitrogen. The content was melted at 115° C. 4,4′-Dicyclohexylmethane diisocyanate (262 mg, 1.00 mmol) and dibutyltin laurate (11.8 μL, 0.10 mol %: 0.020 mmol) were added to the molten liquid, and the molten liquid was stirred for 24 hours at 115° C. in a nitrogen atmosphere. Thus, PEG-PPG Oligomer 2 (second polymer having polyoxyethylene chains and polyoxypropylene chains) was obtained.

The weight average molecular weight (Mw) of resulting Oligomer 2 was 50,000, and the weight average molecular weight/number average molecular weight (Mw/Mn) of Oligomer 2 was 1.95.

2. Measurement of Molecular Weight

A GPC chromatograph of an oligomer was obtained by using DMF (N,N-dimethylformamide) containing lithium bromide at a concentration of 10 mM as an eluent, under the conditions of a flow rate of 1 mL/min. From the resulting chromatogram, the number average molecular weight and the weight average molecular weight of the oligomer were determined as values calculated relative to polystyrene standards.

3. Composition for Molding and Resin Molded Article

### Example 2-1

BACH of Synthesis Example 1 (27.7 mg, 69.5 μmol), PEG-PPG Oligomer 1 of Synthesis Example 2 (34.5 mg, 2.88 μmol), 2-ethylhexyl acrylate (2-EHA, 553 mg, 3.00 mmol), acrylonitrile (AN, 390 mg, 3.00 mmol), and Irgacure 651 (15.5 mg, 60.5 μmop were heated and melted in a sample bottle, and thus a mixed liquid (composition for molding) was produced.

The resulting mixed liquid thus was poured into a stainless steel metal mold having a dimension of length×width×depth of 46 mm×10 mm×1 mm, and the metal mold was covered with a transparent sheet made of polyethylene terephthalate. The mixed liquid was photocured by irradiating the mixed liquid with UV (ultraviolet radiation) at room temperature (25° C.; hereinafter, the same) from above the transparent sheet for 30 minutes, and thus a film-shaped molded article was obtained.

A tube made of polytetrafluoroethylene (trade name: NAFLON (registered trademark) BT tube ⅛B) having an inner diameter of 1.59 mmϕ, an outer diameter of 3.17 mmϕ, and a thickness of 0.79 mm was twined around a stainless steel tube having an outer form of 10 mmϕ. The twined tube was filled with the mixed liquid, and the mixed liquid in the tube was photocured by irradiating the mixed liquid with ultraviolet radiation for 30 minutes at room temperature. Subsequently, a spiral-shaped molded article was taken out from the tube.

The mixed liquid filled in a cup-shaped mold made of polyethylene was photocured by irradiating the mixed liquid with ultraviolet radiation for 30 minutes at room temperature. A cup-shaped molded article was taken out from the mold as a molded article having a three-dimensional shape.

### Reference Example

A mixed liquid was produced in the same manner as in Example 1, except that PEG-PPG Oligomer 1 was not used. Resin molded articles of various shapes were produced in the same manner as in Example 2-1, using the mixed liquid thus obtained.

### Examples 2-2 and 2-3 and Comparative Example 2-1

Mixed liquids were produced at the mixing ratios indicated in Table 2. Resin molded articles of various shapes were produced in the same manner as in Example 2-1, using the mixed liquid thus obtained.

4. Evaluation: Storage Modulus

A short strip-shaped specimen having a width of 5 mm and a length of 30 mm was cut out from a film-shaped molded article. Using this specimen, the storage modulus at 25° C. was measured with a dynamic viscoelasticity analyzer (RSA-G2) manufactured by TA Instruments, Inc. The measurement conditions were as follows.
Distance between chucks: 20 mm
Measurement frequency: 10 Hz
Rate of temperature increase: 5° C./min

Shape Memory Properties

A film-shaped molded article was folded two times, and while in that state, the folds were pressed with a glass tube. It was confirmed that the folded shape substantially did not return to the original shape. A spiral-shaped molded article was extended and defaulted into a rod shape. A cup-shaped molded article was deformed by interposing the molded article between two sheets of glass plates and pressing the molded article in the height direction. A case in which the molded article having various shapes retained the shape after deformation was considered as “good”, and a case in which the shape was not retained was considered as “defective”.

Thereafter, the deformed molded article was immersed in water at 70° C., and it was confirmed by visual inspection that the molded article restored the initial shape within 10 seconds from immediately after immersion. A case in which the molded article restored the initial shape was considered as “good”, and a case in which the molded article did not restore the initial shape was considered as “defective”.

Folding Resistance

In regard to the film-shaped molded articles of Examples, folded portions were restored to the original state, and then those portions were observed by visual inspection and with an optical microscope (100 times). Compared to the state before being folded, a case in which there was no change in the external appearance was considered as “good”, and a case in which abnormalities such as whitening and voids occurred was considered as “defective”.

Measurement of Strength at Break and Elongation at Break

A polyethylene terephthalate (PET) film was spread in a stainless steel metal mold having a dimension of length×width×depth of 46 mm×10 mm×1 mm. A resin composition was poured thereinto, and the metal mold was covered with a transparent sheet made of PET on the resin composition. The resin composition was irradiated with ultraviolet radiation at a dose of 2,000 mJ/cm² from above the transparent sheet at room temperature (25° C.; hereinafter, the same), and thus a resin film was obtained.

A short strip-shaped specimen (width: 8 mm, thickness: 1 mm) was cut out from the resin film thus obtained. This specimen was used to measure the strength at break and the elongation at break using a STROGRAPH T (manufactured by Toyo Seiki Seisakusho Co., Ltd.) under the conditions of room temperature, a distance between chucks of 30 mm, and a tensile rate of 10.0 mm/min.

TABLE 2

| | | Example | Example | Example | Reference | Comparative |
|---|---|---|---|---|---|---|
| | | 2-1 | 2-2 | 2-3 | Example | Example 2-1 |
| First polymer | BACH | 69.5 μmol | 69.5 μmol | 69.5 μmol | 69.5 μmol | 69.5 μmol |
| | 2-Ethylhexyl | 3.00 mmol | 2.00 mmol | 3.00 mmol | 3.00 mmol | — |
| | acrylate | | | | | |
| | Lauryl methacrylate | — | — | — | — | 5.00 mmol |
| | Acrylonitrile | 3.00 mmol | 4.00 mmol | 3.00 mmol | 3.00 mmol | 1.00 mmol |
| Second polymer | Oligomer 1 | 2.88 μmol | 2.88 μmol | — | — | 2.88 μmol |
| PEG-PPG | Oligomer 2 | — | | 2.88 μmol | — | — |
| oligomer | | | | | | |
| Storage modulus | | 1.4 MPa | 10 MPa | 4.0 MPa | 1.2 MPa | 0.1 MPa |
| Film-shaped | Shape retainability | Good | Good | Good | Good | Good |
| molded article | Shape restorability | Good | Good | Good | Defective | Defective |
| Spiral-shaped | Shape retainability | Good | Good | Good | Good | Defective |
| molded article | Shape restorability | Good | Good | Good | Defective | Defective |
| Cup-shaped | Shape retainability | Good | Good | Good | Good | Defective |
| molded article | Shape restorability | Good | Good | Good | Good | Defective |

| | | | | | |
|---|---|---|---|---|---|
| Folding resistance | Good | Good | Good | Defective | Defective |
| Strength at break | 20 MPa | 25 MPa | 20 MPa | 20 MPa | 1 MPa |
| Elongation at break | 250% | 210% | 180% | 70% | 170% |

The resin molded articles of various Examples had excellent folding resistance and exhibited high elongation percentages. Furthermore, the resin molded articles of various Examples had satisfactory shape memory properties. From these results, it was confirmed that according to an aspect of the present invention, a resin molded article having shape memory properties, which exhibited excellent heating-induced shape restorability, is obtained.

### REFERENCE SIGNS LIST

1: Resin molded article (cured product)

1. A curable resin composition, comprising:
radical polymerizable monomers including a first monofunctional radical polymerizable monomer and a second monofunctional radical polymerizable monomer,
wherein the first monofunctional radical polymerizable monomer is a monomer that forms, when polymerized alone, a homopolymer having a glass transition temperature of 20° C. or lower, and
the second monofunctional radical polymerizable monomer is a monomer that forms, when polymerized alone, a homopolymer having a glass transition temperature of 50° C. or higher.

2. The curable resin composition according to claim 1, wherein the total content of the first monofunctional radical polymerizable monomer and the second monofunctional radical polymerizable monomer is 60% by mass or more based on the total amount of the radical polymerizable monomers.

3. The curable resin composition according to claim 1, wherein the first monofunctional radical polymerizable monomer includes 2-ethylhexyl acrylate.

4. The curable resin composition according to claim 1, wherein the second monofunctional radical polymerizable monomer includes at least one selected from the group consisting of acrylonitrile, dicyclopentanyl acrylate, and methyl methacrylate.

5. The curable resin composition according to claim 1, wherein the radical polymerizable monomers further include a bifunctional radical polymerizable monomer and/or a trifunctional radical polymerizable monomer.

6. The curable resin composition according to claim 1, wherein the content of the first monofunctional radical polymerizable monomer is from 5% by mass to 90% by mass based on the total amount of the radical polymerizable monomers, and
the content of the second monofunctional radical polymerizable monomer is from 10% by mass to 95% by mass based on the total amount of the radical polymerizable monomers.

7. A cured product of a curable resin composition,
the curable resin composition comprising radical polymerizable monomers including a first monofunctional radical polymerizable monomer and a second monofunctional radical polymerizable monomer,
wherein the first monofunctional radical polymerizable monomer is a monomer that forms, when polymerized alone, a homopolymer having a glass transition temperature of 20° C. or lower, and
the second monofunctional radical polymerizable monomer is a monomer that forms, when polymerized alone, a homopolymer having a glass transition temperature of 50° C. or higher.
